(19) United States
(12) Patent Application Publication
(10) Pub. No.: US 2010/0304064 A1
(43) Pub. Date: Dec. 2, 2010

(54) METHOD FOR PRODUCING A CAST PART, CASTING MOULD AND CAST PART PRODUCED THEREWITH

(75) Inventor: Roland Huttner, Jesenwang (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/599,937

(22) PCT Filed: May 2, 2008
(86) PCT No.: PCT/DE08/00757

§ 371 Date: Nov. 12, 2009

(30) Foreign Application Priority Data
May 16, 2007 (DE) 102007023152.2

(51) Int. Cl. B29D 22/00; B28B 7/34

(52) U.S. Cl. 428/35.8; 264/317; 249/62

(57) ABSTRACT

A method for producing a cast part from metal, a metal alloy or from plastic, with at least one complex internal structure, in particular with at least one hollow space, by at least one casting mold, is disclosed. The method includes the following steps: a) providing at least one core element, wherein the core element peripherally reproduces the complex internal structure and has a metallic layer on its outer periphery; b) forming a first casting mold or negative mold for producing a positive mold reproducing the cast part, with one or more cast-in core elements; c) casting an enclosure around the positive mold to form a second casting mold or negative mold of the cast part and removing the positive mold; d) filling the casting mold or negative mold with casting material and cooling the casting material down; and e) removing the enclosure and removal of the cast part.

### BACKGROUND AND SUMMARY OF THE INVENTION

This application claims the priority of International Application No. PCT/DE2008/000757, filed May 2, 2008, and German Patent Document No. 10 2007 023 152.2, filed May 16, 2007, the disclosures of which are expressly incorporated by reference herein.

The present invention relates to a method for producing a cast part from metal, a metal alloy or from plastic with at least one complex internal structure, in particular with at least one hollow space, by means of at least one casting mold. The invention relates further to a casting mold for producing a cast part from metal, a metal alloy or from plastic with at least one complex internal structure, in particular with at least one hollow space, as well as a cast part.

A plurality of methods for producing cast parts from metal, a metal alloy or from plastic are known from the prior art. In the traditional casting methods, cores are used for producing complex internal structures when these cannot be represented by the geometry of the, for example, “lost model.” The cores are normally made of ceramic; they remain in the mold during the casting process and are released after the mold cools down. It is crucial in this process that the openings in the cast part are designed in such a way that releasing is possible. What is disadvantageous about the known method, however, is that a plurality of cast parts with complex internal structures can only be produced with great difficulty or not at all with the known manner.

Therefore, the objective of the present invention is to provide a method of the type cited at the outset, which facilitates or makes possible the production of cast parts with complex internal structures. Furthermore, it would be desirable to provide a casting mold of the type cited at the outset, which facilitates or makes possible the production of cast parts with complex internal structures.

An inventive method for producing a cast part from metal, a metal alloy or from plastic, with at least one complex internal structure, in particular with at least one hollow space, comprises at least one casting mold and the following steps: a) providing at least one core element, wherein the core element peripherally reproduces the complex internal structure and has a metallic layer on its outer periphery; c) casting an enclosure around the positive mold to form a second casting mold or negative mold of the cast part and removing the positive mold; d) filling casting material into the second casting mold or negative mold and cooling the casting material down; and e) removing the enclosure and removal of the cast part. The inventive method makes it possible to produce cast parts with complex internal structures without further ado.

The following step—“b) forming a first casting mold or negative mold for producing a positive mold reproducing the cast part, with one or more cast-in core elements”—is preferably carried out between the aforementioned steps a) and c).

Complex internal structures can be, for example, cooling channels. In addition, the metallic layer formed on the outer periphery of the core element protects the internal structure from the areas of the cast part surrounding it because the metallic layer remains in the finished cast part. According to one embodiment, the core element in this case can be made of a hollow metal core. The hollow metal core can in turn be produced by means of a generative manufacturing method, in particular a rapid prototyping method. However, it is also possible for the core element to be made of a basic mold made from a substrate material that can be melted out, wherein the substrate material is coated on its outer surface with a metallic layer. The basic mold can in turn be produced by means of a generative manufacturing method, in particular a rapid prototyping method. The metallic layer formed on the outer surface of the basic mold or the outer surface of the substrate material can be applied electrochemically. In particular, a metal coating method can be used in this case, which is suited especially for applying metal to plastic parts. According to additional embodiments of the inventive method, the basic mold may be embodied to be hollow or solid. Instead of a solid formation of the basic mold, support elements can also be arranged in a hollow basic mold. In addition, according to process step e), in those cases in which the core element is made of a basic mold from a substrate material that can be melted out, this is melted out of the finished cast part. Basically, all materials that can be used and melted out, on the one hand, in a generative manufacturing method, in particular a rapid prototyping method, can be used as materials for the basic mold or the substrate material.

In another advantageous embodiment of the inventive method, the metallic layer is made of a metal or a metal alloy, wherein the metal or the metal alloy has a higher melting point than the casting material. This guarantees that the metallic layer remains in the cast part and the protective function with respect to the complex internal structure is maintained. For example, the casting material may be made of aluminum and the metallic layer of copper or a copper alloy.

In a further advantageous embodiment of inventive method, the first casting mold or negative mold is made of plastic or silicone. As a result, it is possible to generate the first casting mold or negative mold relatively quickly.

In another advantageous embodiment of the inventive method, the positive mold is made of a metal that melts easily, in particular wax. Plugging the first casting mold or negative mold with, for example, wax produces a detailed, faithful reproduction of the cast part being cast. In addition, producing a so-called wax model facilitates its subsequent removal from the second casting mold or negative mold. In addition, it is possible, to attach at least one sprue and at least one open riser to the positive mold in process step d). This also facilitates pouring the casting material into the second casting mold or negative mold, and, in addition, it thereby results in increased casting accuracy.

In a further advantageous embodiment of the inventive method, the enclosure formed in process step c) is made of ceramic. This material selection is advantageous, because ceramic, on the one hand, makes a precise casting of the positive mold possible and, on the other hand, can be removed again from the finished cast part without further ado.

In another advantageous embodiment of the inventive method, according to process step e) any potentially projecting parts of the core element are removed.

In a further advantageous embodiment of the inventive method, the thickness of the core element or the thickness of the metallic layers is 0.5 to 5 mm. As a result, sufficiently great stability of the metallic layer is guaranteed on the one hand. On the other hand, the metallic layer does not negatively impact the design of the internal structures that it surrounds.

An inventive casting mold for producing a cast part from metal, a metal alloy or from plastic with at least one complex internal structure, in particular with at least one hollow space, has in the region of the complex internal structure a metallic layer for delimitation with respect to the internal structure. On the one hand, it is possible to simply produce cast parts with complex internal structures with this type of casting mold. On the other hand, the inventive casting mold guarantees that the complex internal structure is protected from the casting material surrounding it. The metallic layer in this case may be made of a metal or a metal alloy, wherein the metal or the metal alloy has a higher melting point than the casting material. For example, copper or a copper alloy may be used as metallic layer with aluminum as the casting material.

In another advantageous embodiment of inventive casting mold, the metallic layer is made of a hollow metal core, wherein the hollow metal core is produced by means of a generative manufacturing method, in particular a rapid prototyping method. However, it is also possible for the metallic layer to be produced by means of a core element comprised of a basic mold made of a substrate material that can be melted out, which is coated with the metallic layer on its outer surface. The basic mold may also be produced by means of a generative manufacturing method, in particular a rapid prototyping method. The metallic layer may also be applied to the basic mold electrochemically in this case. In particular the methods known under the procedural term “metal coating” have proven to be advantageous. In addition, the basic mold may be hollow or solid, and support elements embodied in a hollow basic mold are also conceivable.

According to a further advantageous embodiment of the inventive casting mold, the thickness of the metallic layers is 0.5 to 5 mm. As a result, adequate protection of the internal structure with respect to the surrounding casting material is guaranteed, on the one hand, and, on the other hand, the thickness is so low that the structure of the internal structure itself is not impacted by the metallic layer.

In another advantageous embodiment of the inventive casting mold, the basic mold of the core element is produced by means of a generative manufacturing method, in particular a rapid prototyping method. Basically, all materials that can be processed and melted out by means of a generative manufacturing method, in particular a rapid prototyping method, may be used as the materials for the basic mold or the substrate material.

An inventive cast part is produced according to a method with the features described in the foregoing or with a casting mold according to the features described in the foregoing. For example, the cast part may be a part of an aircraft engine or a gas turbine.

Additional advantages, features and details of the invention are yielded from the following description of a graphically depicted exemplary embodiment.

### BRIEF DESCRIPTION OF THE DRAWINGS

FIG. 1 is a schematic representation of two core elements used according to the inventive method;

FIG. 2 is a schematic sectional view through a partial region of a core element used according to the inventive method;

FIG. 3 is a schematic, partial sectional representation of a first casting mold or negative mold used according to the inventive method with inserted core elements;

FIG. 4 is a schematic representation of a positive mold used according to the inventive method with inserted core elements;

FIG. 5 is a schematic representation of a cast part produced according to the inventive method with inserted core elements; and

FIG. 6 is a schematic representation of a cast part produced according to the inventive method.

### DETAILED DESCRIPTION OF THE DRAWINGS

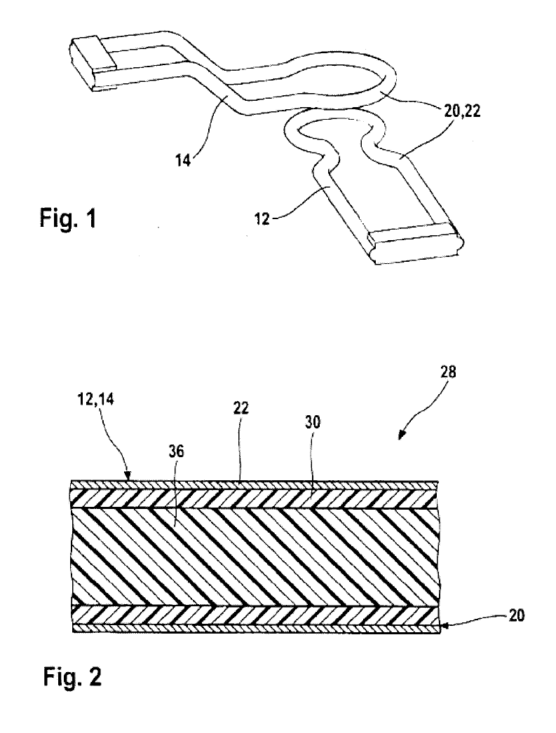

FIG. 1 shows a schematic representation of two core elements 12, 14 used according to the inventive method. The core elements 12, 14 peripherally reproduce a complex internal structure 18 (cf. FIG. 6) and feature a metallic layer 22 on their respective outer periphery 20. The complex internal structures 18 reproduced by the core elements 12, 14 are cooling channels of a cast part 10, namely of a protective gas nozzle (cf. FIG. 6). In the depicted exemplary embodiment, the core elements 12, 14 are each made of a basic mold 28 made from a substrate material 30 that can be melted out, wherein the substrate material 30 is coated on its outer surface with the metallic layer 22. This type of structure of the core elements 12, 14 is described in FIG. 2, wherein FIG. 2 depicts a schematic sectional view through a partial region of the core elements 12, 14. In addition, one can see that the core elements 12, 14 are embodied to be solid. To this end, the hollow space formed by the substrate material 30 is filled in by a supporting material 36. It must be possible to melt out both the substrate material 30 as well as the supporting material 36. In addition, these are materials that can be processed by means of a rapid prototyping method. Plastics have proven to be particularly suitable in this case. In addition, it is possible for the substrate material 30 and the supporting material 36 to be made of the same material. However, different materials may also be used. The core elements 12, 14 are used in a process step a) with a method for producing a cast part from metal, a metal alloy or from plastic with at least one complex internal structure 18, in particular with at least one hollow space using a casting mold.

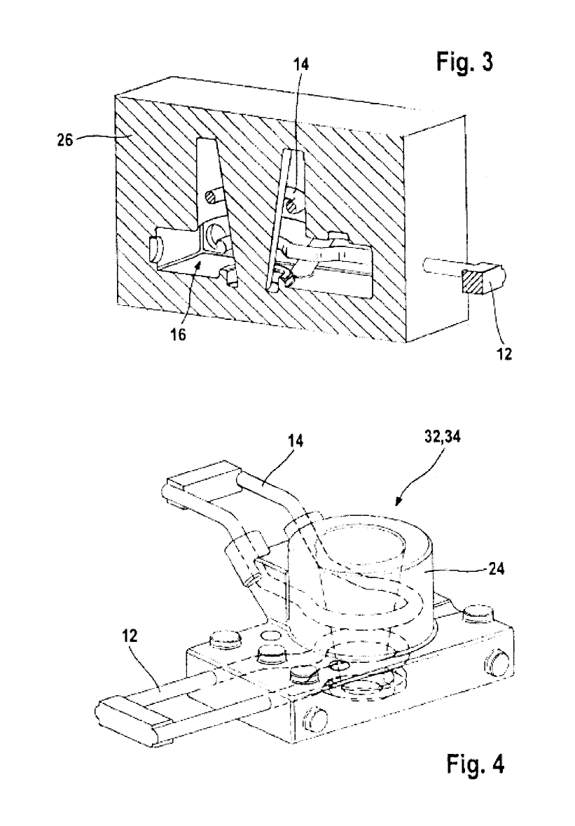

The formation of a first casting mold or negative mold 26 for producing a positive mold 24 reproducing the cast part 10 with the two cast-in core elements 12, 14, is carried out in a further process step b). Forming the first casting mold or negative mold 26 is depicted in FIG. 3 as a schematic, partial sectional representation. One can see that the core elements 12, 14 have been inserted into the first casting mold or negative mold 26. A hollow space 16 of the first casting mold or negative mold 26 is filled in with a material that can be melted out, in particular wax, so that the core elements 12, 14 are embedded in the cited positive mold 24. The positive mold 24 is depicted in FIG. 4. In addition, FIG. 4 indicates that a sprue 32 and an open riser 34 are attached to the positive mold 24. After casting an enclosure around the positive mold 24, in particular with an enclosure to form a second casting mold and negative mold of the cast part 10, the positive mold 24 is removed, in particular melted out. The enclosure for forming the second casting mold or negative mold is made of ceramic for example. Filling the casting material into the second casting mold or negative mold, and cooling the casting material according the further process steps c) and d), are followed in a final process step by e) removing the enclosure and removal of finished cast part 10.

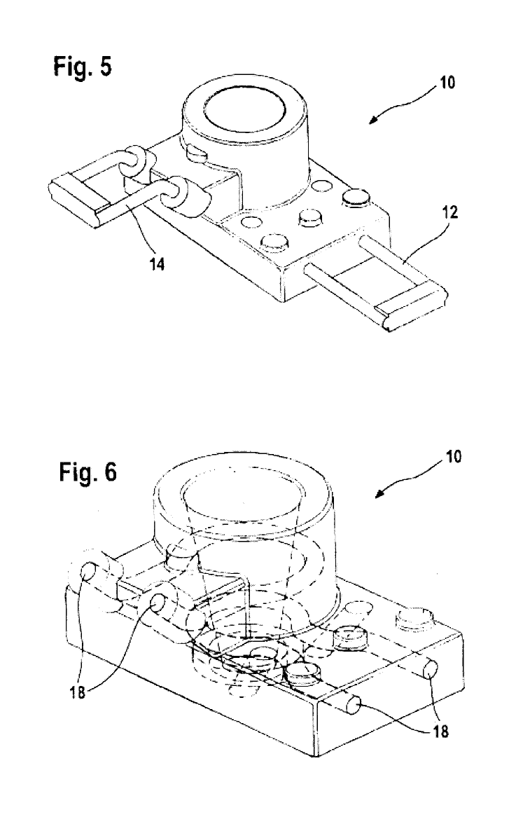

FIG. 5 shows a schematic representation of a cast part 10 produced in this manner with the core elements 12, 14 still inserted. The projecting cores are then separated, the basic mold 28 or the substrate material 30 and the supporting material 36 are melted out so that ultimately the finished cast part 10 that is depicted schematically in FIG. 6 remains. One can see the complex internal structures 18, namely the cooling channels of the cited protective gas nozzle.

The rapid prototyping method used for producing the core elements 12, 14 may be, for example, the procedural families of stereo lithography, laser sintering, the layering (laminating) method, the extrusion process or 3D printing.

1-27. (canceled)

28. A method for producing a cast part from metal, a metal alloy or from plastic with a complex internal structure by a casting mold, comprising the steps of:
a) providing a core element, wherein the core element peripherally reproduces the complex internal structure and has a metallic layer on an outer periphery of the core element;
c) casting an enclosure around a positive mold to form a negative mold of the cast part and removing the positive mold;
d) filling the negative mold with casting material and cooling the casting material down; and
e) removing the enclosure and removing the cast part.

29. The method according to claim 28, wherein between the steps a) and c), a step b) of forming a second negative mold for producing the positive mold is performed.

30. The method according to claim 28, wherein the core element is made of a hollow metal core.

31. The method according to claim 30, wherein the hollow metal core is produced by a generative manufacturing method.

32. The method according to claim 28, wherein the core element is made of a basic mold made from a substrate material that is meltable and wherein the substrate material is coated on an outer surface with the metallic layer.

33. The method according to claim 32, wherein the basic mold is produced by a generative manufacturing method.

34. The method according to claim 32, wherein the metallic layer is applied electrochemically.

35. The method according to claim 32, wherein the basic mold is hollow or solid.

36. The method according to claim 32, wherein the metallic layer is made of a metal or a metal alloy and wherein the metal or the metal alloy has a higher melting point than the casting material.

37. The method according to claim 29, wherein the second negative mold is made of plastic or silicone.

38. The method according to claim 28, wherein the positive mold is made of wax.

39. The method according to claim 29, wherein a sprue and an open riser are attached to the positive mold in process step b).

40. The method according to claim 28, wherein the enclosure formed in process step c) is made of ceramic.

41. The method according to claim 28, wherein in process step e) any projecting parts of the core element are removed.

42. The method according to claim 32, wherein in process step e) the substrate material is melted out.

43. The method according to claim 32, wherein a thickness of the core element or a thickness of the metallic layer is 0.05 to 5 mm.

44. A casting mold for producing a cast part from metal, a metal alloy or from plastic with a complex internal structure wherein the casting mold has in a region of the complex internal structure a metallic layer for delimitation with respect to the internal structure.

45. The casting mold according to claim 44, wherein the metallic layer is made of a hollow metal core.

46. The casting mold according to claim 45, wherein the hollow metal core is produced by a generative manufacturing method.

47. The casting mold according to claim 44, wherein the metallic layer is produced by a core element made of a basic mold made from a substrate material that is meltable and which is coated on an outer surface with the metallic layer.

48. The casting mold according to claim 47, wherein the basic mold is produced by a generative manufacturing method.

49. The casting mold according to claim 44, wherein the metallic layer is applied electrochemically.

50. The casting mold according to claim 47, wherein the basic mold is hollow or solid.

51. The casting mold according to claim 44, wherein the metallic layer is made of a metal or a metal alloy and wherein the metal or the metal alloy has a higher melting point than a casting material.

52. The casting mold according to claim 44, wherein a thickness of the metallic layer is 0.05 to 5 mm.

53. A cast part produced according to a method of claim 28.

54. The cast part according to claim 53, wherein the cast part is a part of an aircraft engine or a gas turbine.

55. A cast part produced with a casting mold according to claim 44.

56. The cast part according to claim 55, wherein the cast part is a part of an aircraft engine or a gas turbine.
